(19) United States
(12) Patent Application Publication
(10) Pub. No.: US 2011/0145786 A1
(43) Pub. Date: Jun. 16, 2011

(54) REMOTE COMMANDS IN A SHELL ENVIRONMENT

(75) Inventors: Wassim FAYED, Sammamish, WA (US); Lukasz ANFOROWICZ, Redmond, WA (US); Hemant MAHAWAR, Redmond, WA (US)

(73) Assignee: MICROSOFT CORPORATION, Redmond, WA (US)

(21) Appl. No.: 12/638,444

(22) Filed: Dec. 15, 2009

(51) Int. Cl. G06F 9/44; G06F 15/16; H04L 9/32

(52) U.S. Cl. 717/115; 709/217; 726/5

(57) ABSTRACT

A shell environment may include a mechanism for executing commands on a remote device. The mechanism may retrieve remote commands and command metadata from the remote device and create scripts on a local device that may emulate the remote commands. The scripts may include authentication and other security measures, as well as help information provided by the remote device. The scripts may be grouped as a module and may be stored in a local cache. The cache may be periodically validated and when updates are available, the cache may be updated with new versions.

### BACKGROUND

Shell environments are often used for accessing operating system and applications within a computer. Shell environments may be command line interfaces or graphical user interfaces. Many shell environments support scripting, which allows a user to create a short set of commands that may be interpreted and executed by the shell.

Some shell environments may provide very complex and powerful scripting capabilities. The scripts may include looping, pipelining, and many other powerful capabilities that may enable complex tasks to be executed with ease.

### SUMMARY

A shell environment may include a mechanism for executing commands on a remote device, such as a remote server in a client-server environment. The mechanism may retrieve remote commands and command metadata from the remote device and create scripts on a local device that may emulate the remote commands. The scripts may include authentication and other security measures, as well as help information provided by the remote device. The scripts may be grouped as a module and may be stored in a local cache. The cache may be periodically validated and when updates are available, the cache may be updated with new versions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a network environment in which shell environment may operate.

FIG. 2 is a flowchart illustration of an embodiment showing a method of populating a shell environment with remote commands.

FIG. 3 is a flowchart illustration of an embodiment showing a method for using remote commands in a shell environment.

FIG. 4 is a flowchart illustration of an embodiment showing a method for retrieving help information.

FIG. 5 is a flowchart illustration of an embodiment showing a method for updating remote commands.

### DETAILED DESCRIPTION

A shell environment may gather commands from a remote device so that those commands may be integrated into the shell environment and used in the same manner as local commands. The shell environment may query the remote device to identify any available commands, gather metadata about those commands, and create local scripts or other representation of the remote commands. The scripts may be used as local commands, and may have various features such as help features and other features that enable the remote commands to be utilized similarly to local commands.

The metadata gathered from the remote device may include parameters and complex data types that may be used to communicate with the remote device. The parameters and data types may define information that is passed to the remote device for a certain command, as well as the information that may be returned from the remote device.

In many instances, the remote commands may operate with authentication or permissions. An authenticated session may be established between a local device and remote device from the shell environment, and the session may be periodically renewed in some instances. An authentication mechanism may involve transmitting credentials to the remote server, using a third device such as a domain controller, or other mechanism.

The remote commands may be used within the shell environment with many of the features and capabilities of local commands. Many shell environments have features such as autocompletion, where a user may type in a portion of a command name and the remainder of the command name may be filled in automatically. In some autocompletion systems, a user may be able to use the tab key to cycle through available options, for example. The remote commands may be configured to be used with such autocompletion mechanisms.

The shell environment may operate as a mechanism for a client device to discover the set of available commands that may be executed on a remote device, such as a server. The information returned by this mechanism may be sufficient for the client to create structurally valid pipelines. Because the information is retrieved and used at a later time, the information may not remain valid after it has been retrieved as the set of commands exposed by the server may change at any time.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

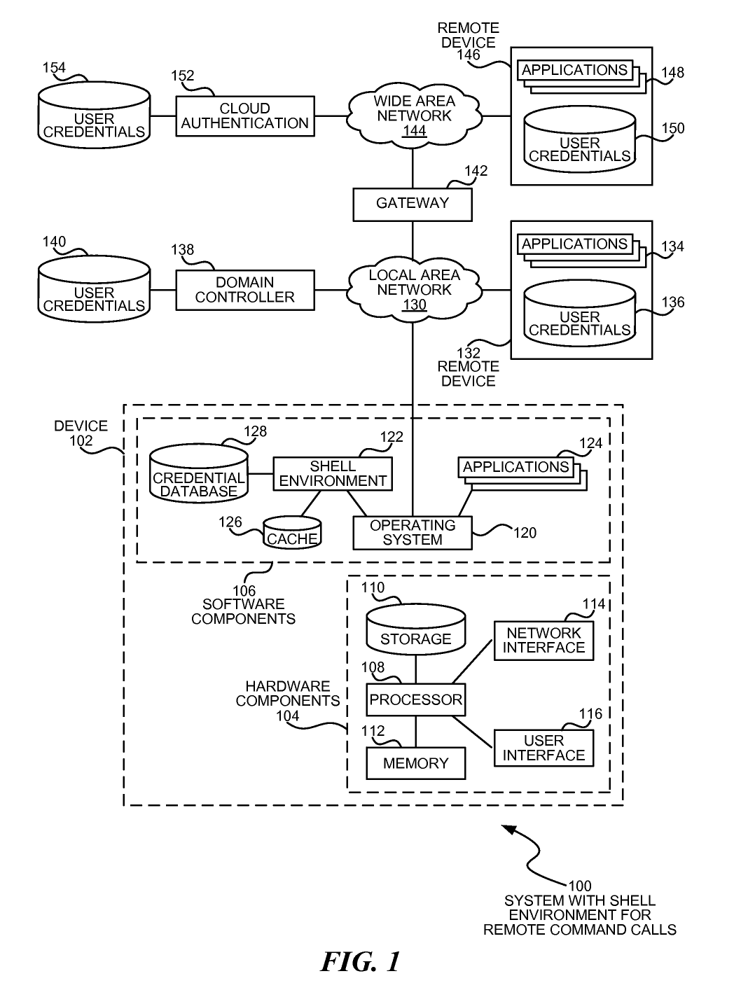

FIG. 1 is a diagram of an embodiment 100, showing a system with a shell environment that can execute remote commands. Embodiment 100 is a simplified example of a device and network environment in which a shell environment may be used to execute remote commands within a local area network and wide area network.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates a system that may use a shell environment to execute commands against remote devices. The remote commands may be loaded into the shell environment as scripts or other mechanisms by which those commands may be manipulated and executed in similar manners as locally executable commands.

A shell environment may be any mechanism that enables a user to access operations of an operating system. In many embodiments, a shell environment may be a command line interface where a user may create and execute scripts. Some such embodiments may have powerful mechanisms and features that may aid a user in performing complex tasks. For example, many command line shell environments may support pipelining, where the output of one command may be fed into the input of another command.

A script may be used to automate a series of tasks in many shell environments. A script may be a series of commands that may be interpreted by the shell, and many scripts may accept input data, arguments, parameters, and other input. In many cases, the script may operate identically to a command that may be native to the shell environment.

The shell environment may be a command line interface. A command line interface may have a prompt at which a user may type a command for the shell to execute. Many command line interfaces may validate a command prior to execution, and some may also capture or redirect a command's output. Some command line interfaces may allow character strings or aliases to be assigned to commands.

The shell environment may gather remote commands and make the remote commands available within the shell environment. The remote commands may be implemented as scripts or other mechanisms by which the remote commands may be used within the shell environment in a similar manner as native commands of the shell environment.

Throughout this specification and claims, the terms “local” and “remote” are used to designate items that refer to or are executed by a system on which the shell environment operates and other devices, respectively. “Local” commands, for example, are commands that may be executed on the same device as the shell environment, while “remote” commands are commands are called from a local device but are executed on another device. A remote device may be any device other than the device on which the shell environment may operate, such as a server or other device.

The device 102 is illustrated as a local device in embodiment 100. The device 102 may be any type of computing device. For example, the device 102 may be a desktop computer, laptop computer, server computer, netbook computer, or other conventional computer device. In other examples, the device 102 may be a portable telephone, personal digital assistant, network switch, network appliance, or other device.

The device 102 is illustrated as having a set of hardware components 104 and a set of software components 106. The components illustrated are merely one example of a hardware and software configuration that may be used.

The hardware components 104 may include a processor 108 that may access a random access memory 112 as well as nonvolatile storage 114. The hardware components 104 may also include a network interface 114 and a user interface 116.

The software components 106 may include an operating system 120. A shell environment 122 may access the operating system functions as well as various applications 124, e.g., through operating system 120. The shell environment 122 may be used to start, stop, and operate the applications 124 as well as various commands, functions, or services within the operating system 120.

The shell environment 122 may be a mechanism by which a user may cause various applications 124 to perform certain functions. A user may be able to execute a command within the shell environment 122 that causes an application 124 to perform a task. The command may have various parameters, modifiers, or other information that causes the application to perform a specific function on specific data, for example.

When the shell environment 122 is configured with commands from a remote device, information from the remote device may be stored in a local cache 126. For example, the shell environment 122 may request a set of commands from the remote device 132. The remote device 132 may respond with metadata about the available commands from which scripts or other information may be generated. The scripts that may be used to access the applications 134 on the remote device 132. The metadata, scripts, and other information may be stored in a local cache 126.

The cache 126 may be used to store information that is received from a remote device. Some embodiments may periodically determine if the information stored in the cache 126 is up to date. For example, an embodiment may compare a hash value for data stored in the cache 126 with a hash value of data available on a remote device to determine if the remote device has updated information. If updated information exists, the information may be downloaded and may replace the data stored in the cache.

The shell environment 122 may enable a user to execute remote commands that may cause actions to occur on other devices, and in some cases those actions may have access limitations. For example, some operations may be limited to administrators or users with administrator privileges. In another example, certain operations may be permitted or denied if the user is a member of certain user groups. For example, an administrator may be permitted to configure an electronic mailbox, but may not be permitted to view the contents of the same mailbox. A user assigned to the mailbox may be permitted to view the contents, but not change the configuration of the mailbox.

Remote commands may be performed when a user presents credentials to the remote device in some instances. In some embodiments, a shell environment 122 may establish a session with a remote device 132 by presenting credentials to the remote device 132. Once an authenticated session is established, commands and other information may be passed back and forth between the shell environment 122 and the remote device 132. In other embodiments, credentials may be presented with each remote command to authenticate a command request.

In some embodiments, a shell environment 122 may have a credential database 128 in which credentials may be stored. The credentials may be user identification and passwords, or other credentials such as encryption keys, codes, or other credentials. The shell environment 122 may transmit a set of credentials to a remote device during an authentication operation, and the shell environment 122 may use credentials from the credential database 128 so that a user may not have to type a password or present other credentials each time.

Credentials may be provided by a third device. For example, a domain controller 138 may maintain a database of user credentials 140. A user of the shell environment 122 may present credentials that may be authenticated by the domain controller 138, and the remote device 132 may recognize the same credentials or authentication mechanism of the domain controller 138.

The remote device 132 may have its own set of user credentials 136. The user credentials 136 may be a separate set of user identification and passwords or other credentials that may be assigned to various users. A user of the shell environment 122 may log into the device 102 using one set of credentials that may be authenticated by the device 102 or the domain controller 138, but may use a second user identification and password to access certain functions of the remote device 132. The second user identification and password may be stored in the user credentials 136.

Remote devices may also include devices accessed over the Internet or other wide area network. A gateway 142 may connect the local area network 130 with a wide area network 144, which may be the Internet in some embodiments. A remote device 146 may be accessed from the shell environment 122 in a similar manner as the remote device 132.

The remote device 146 may be a web service or other remote server on which applications 148 may be executing. The shell environment 122 may interact with the remote device 146 in a similar manner as the remote device 132 in the local area network 130. Some embodiments may use a Uniform Resource Identifier (URI) or other similar addressing mechanism that may identify the remote device 132 within the local area network 130 in a similar manner as the remote device 146. Such embodiments may have common mechanisms for retrieving command metadata and executing remote commands.

Other embodiments may treat the remote device 132 in the local area network 130 differently from the remote device 146 on the wide area network 144. Some such embodiments may use different addressing schemes for the respective remote devices, for example. Other embodiments may use different security measures and authentication mechanisms for the two different remote devices. For example, communications with the remote device 146 on the wide area network 144 may be performed with a high level of encryption, while the communications with the remote device 132 on the local area network 130 may be performed with no encryption or a low level of encryption.

The remote device 146 may have a set of user credentials 150 that may be used to authenticate a user identity and define access privileges to the various applications 148. The remote device 146 may be a web service, for example, to which a user or organization may subscribe by paying a fee. In such embodiments, the user credentials 150 may be updated to reflect the current status of the user's subscription, including which operations the user may be permitted to perform.

A cloud authentication 152 mechanism may be used in some embodiments to authenticate a user. The cloud authentication 152 may have a database of user credentials 154. The cloud authentication 152 may be presented credentials and may return a token that may verify the credentials. The token may be recognized by the remote device 146 as verification of authentication.

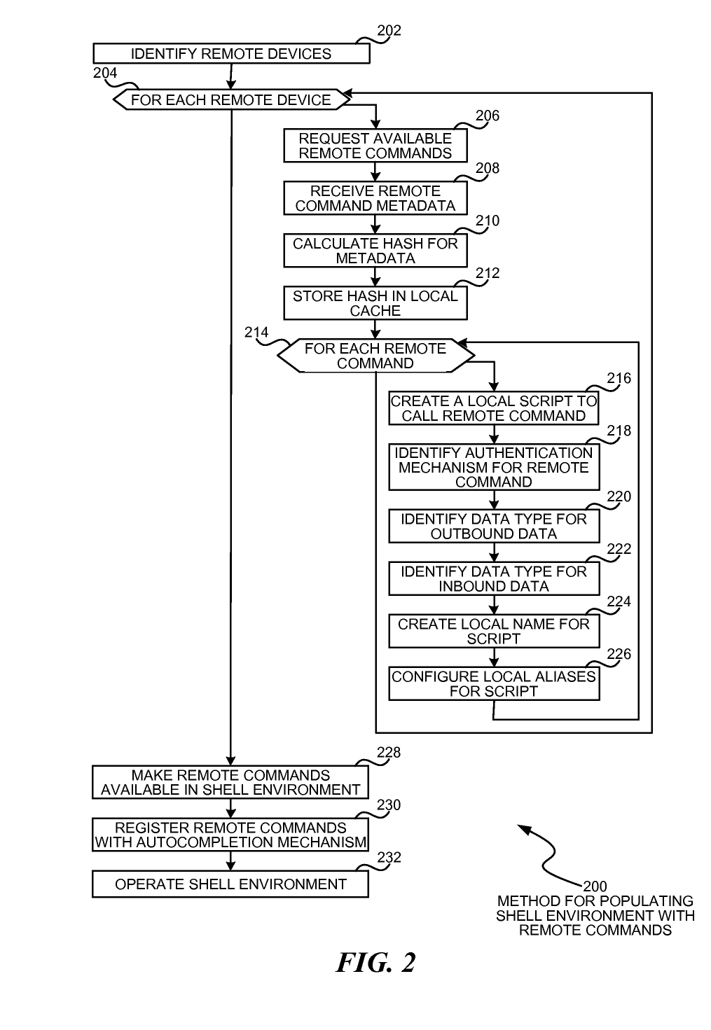

FIG. 2 is a flowchart illustration of an embodiment 200 showing a method for populating a shell environment with remote commands. Embodiment 200 is a simplified example of one process that may be used to gather remote commands and configure a shell environment to use the remote commands.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is a simplified process where remote devices may be queried to provide metadata about the commands available on the remote device. Each command may be integrated into the shell environment by creating a script by which the remote command may be called from the shell environment.

Embodiment 200 is an example of a process by which a group of remote commands may be gathered. Embodiment 200 may be performed at any time during a shell environment operation. In many cases, the process of embodiment 200 may be performed when a shell environment is configured or when remote devices are added to a network environment. After the remote commands are processed using embodiment 200, the stored commands may be periodically updated. An example of a process for updating the commands may be found in embodiment 500 presented later in this specification.

Remote devices may be identified in block 202. The remote devices may be any device other than the local device, which may be the device on which the process of embodiment 200 is performed.

In some embodiments, a list of remote devices may be provided by a domain controller or some other source. A domain controller may maintain entries for various servers and services that may be accessed by a shell environment, and in some embodiments, the entries may include remote devices that are outside of a local area network. When a web service or other remote device is configured, an entry in a domain controller's directory may be created so that a shell environment or other entity may gather information to establish a communication with the web service or remote device.

A list of remote devices may be automatically generated when a shell environment is initially configured or each time the shell environment is started. In such embodiments, an automated crawler or other mechanism may detect available remote devices.

Each remote device may be processed in block 204.

A request may be made to the remote device for available remote commands in block 206 and the remote command metadata may be received in block 208.

The commands that are received in block 208 may be all of the commands that a remote device may be capable of performing, in some embodiments. In other embodiments, the commands received in block 208 may be a subset of commands for which the current user of the shell environment may have permission to access. In either case, the remote device may request the user credentials prior to executing the command. Other subsets of commands may also be provided in certain circumstances.

When all of the available commands are received in block 208, the commands may include commands for which the current user or another user of the shell environment may not have permission to execute. In such cases, some embodiments may include permissions or credential settings for each of the commands so that the shell environment may make the commands available or unavailable to a particular user. The shell environment may evaluate the user credentials and may permit or deny access to the command within the shell environment. In some cases, the shell environment may show the command but may use a visual indicator or message to illustrate that the command is unavailable. Other embodiments may make all of the commands available but may return an error message when a user's credentials are not accepted by a remote device for a specific command.

The remote command metadata in block 208 relates to receiving metadata about a particular command. The receipt of such metadata may occur in receiving the commands themselves as part of block 206 or may be obtained by specific request for specific metadata relating to a command received in block 206. The metadata may include many different types of information about a command. For example, the command metadata may include a command name, parameter names, aliases for parameters, extended type system for outgoing data to the remote device as well as incoming data returned from the remote device, schema for data passed to and received from the remote device, minimum set of credentials used to access the command, and many other metadata.

The command metadata may include sufficient metadata so that a shell environment may create a script that can call the command. Such a script may also include an address for the remote device, which may be in the form of an Internet Protocol (IP) address, a Uniform Resource Identifier, or other addressing scheme.

A hash for the metadata may be created in block 210 and stored in block 212. The hash may be used to determine if the metadata have changed, and then to update the metadata and the associated scripts. An example of such a process that may use the stored hash values is presented in embodiment 500 presented later in this specification.

Each command may be processed in block 214.

A local script may be created in block 216 that may call the remote command. The script may be populated and configured by the next several blocks 218-226. In other embodiments, the script may be retrieved from the remote device.

The local script may be used by the shell environment in the same manner as a conventional command. For example, autocompletion mechanisms may present the scripts in the same manner as a native or conventional command, the scripts may be executed in the same manner as a conventional command, and help information may be requested and presented in the same manner.

The local script in block 216 may identify various parameters that may be configured and passed to the remote device. In some embodiments, the parameters may be default settings that a user may or may not be able to override. The default settings may be configured in the script so that if no other value is given for the parameter, the default setting may be transmitted to the remote device.

In some embodiments, the script may include identifiers, names, or classifications for parameters that may be permitted for the script. These parameters may be used by the shell environment to process the command in a specific manner, or the parameters may be passed to the remote device to cause the remote device to operate in a specific manner. In some embodiments, the script may define how certain parameters may be manipulated, processed, or changed between a syntax used in the shell environment to a syntax used by the remote device.

Authentication mechanisms may be identified in block 218 for the remote command. The authentication information in block 218 may include types or descriptions of credentials that may be recognized by the remote device. For example, the remote device may be configured to accept authenticated tokens from a third device, such as a domain controller or cloud authentication mechanism. In such an example, a shell environment may use the authentication information to establish an authenticated session with a remote device prior to transmitting a request for a command.

The authentication mechanisms in block 218 may also include parameters or qualifications of the credentials for specific commands. For example, some commands may be executed by administrators, and those commands may be marked as being limited to users with administrator credentials. In such an example, a shell environment may perform some filtering of the commands to a user based on the user's credentials, group membership, and other permissions or authority assigned to the user.

Outbound and inbound data types may be identified in blocks 220 and 222, respectively. Many remote commands may receive and transmit data, and those data may be defined by simple or complex data types, schema, and other mechanisms. Many shell environments implement pipelining, where the output of one command may be linked to the input of another command. Such shell environments often use schema or data types to match the information from one command to another in order to implement pipelining.

A shell environment may use the outbound data types to configure data to match what the remote device expects to receive. In a simple example, a script may be executed and given an integer value as input data. The shell environment may determine that the remote device is expecting a real number as an input value, and the shell environment may convert the integer number to a real number prior to transmitting the output data.

A local name may be created for the script in block 224, and local aliases may be created in block 226. The local name for the script may be the same or different from the remote command. In many embodiments, the local name of the script may be the remote name, or may be modified to include the remote name and an identifier for the remote device. For example, a remote command of get.mailbox may have a script named get.mailbox or get.mailbox.corpserver. The ‘corpserver’ element of the second name may be the name of the remote device.

In some cases, the remote command names may conflict with names of conventional or native commands or from remote commands from other devices. In the example above, a second set of remote commands from a remote device named ‘deptserver’ may be named get.mailbox.deptserver.

Some embodiments may permit two or more scripts to have the same name. In such embodiments, the shell environment may use a modifier or parameter to select between the different scripts. Using the example above, a command of “get.mailbox-deptserver” may execute the get.mailbox script and the “-deptserver” parameter may indicate which of the get.mailbox scripts to execute. In some such embodiments, a “get.mailbox” command may return an error because the shell environment may not be able to discriminate between several scripts or commands having the same name, until a parameter is used to identify a specific command or script.

In many embodiments, a script may have one or more aliases. Each alias may be another name or mechanism by which the script may be called. Some shell environments may have multiple manners or syntaxes by which a script may be called, and aliases that comply with each syntax may be created in block 226.

After each remote command is processed in block 214, and each remote device is processed in block 204, the remote commands may be made available in the shell environment in block 228.

The remote commands and scripts may be registered with an autocompletion mechanism in block 230. In some environments, such registration may be an express operation where the commands may be individually added to an autocompletion mechanism. In other environments, an autocompletion mechanism may automatically detect the presence of the scripts and include the scripts without having an express registration occur.

An autocompletion mechanism may be any system that helps a user select a command. In some embodiments, a user may type one or two letters of a command and an autocompletion mechanism may attempt to complete the command. A user may tab, space, or use other keystrokes to advance through multiple selections of available command.

In many embodiments, an autocompletion mechanism may add parameters or other information to a command line or other interface for the user to fill out. The parameters or other information may be gathered from the script and may aid the user in typing the command with the proper syntax, spelling, and including the minimum and optional parameters.

After all of the scripts are added to the shell environment, the shell environment may be operated in block 232. Embodiment 300, presented below, may be one example of how the scripts may be used within the shell environment.

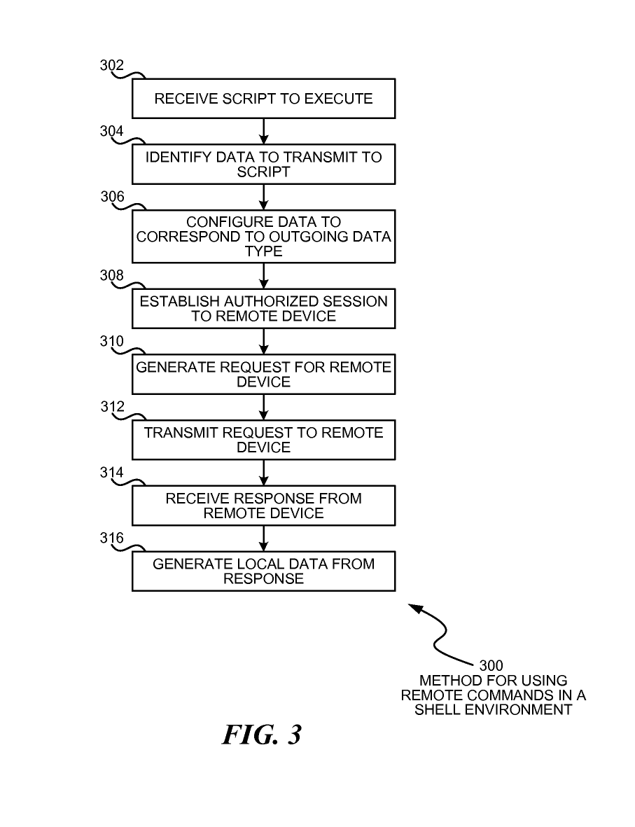

FIG. 3 is a flowchart illustration of an embodiment 300 showing a method for using a remote command script within a shell environment.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is an example of a process that may be performed by a shell environment to execute a script that includes a remote command. The script may be a script created by the process of embodiment 200.

The script may be received in block 302. The script may be executed by a user typing the script name on a command line, or the script name may be included in another script, or some other mechanism may present the script for execution.

In some cases, the script may be used with other scripts by joining the scripts together with a pipeline. The pipeline is a mechanism that may match the output of a first script or command with the input of a second script or command. The pipeline mechanism may match the scripts or commands together by analyzing the data types or other metadata of the scripts. Embodiment 300 illustrates how one of the scripts may be executed as either the first or second script in a pipeline.

In block 304, data to the transmitted to the script may be identified. In some cases, a script may be executed with certain input data, such as when a shell environment implements pipelining or when the script is executed against a data set.

The data may be configured in block 306 to conform to schema, data types, or other data definitions within the script. The data may be transformed, modified, reconfigured, or otherwise manipulated to conform to a form in which the remote device may be able to process the data.

An authorized session may be established in block 308 between the shell environment and the remote device. In some embodiments, the authorized session may be established for a period of time and may be used for multiple remote commands during that time. In other embodiments, an authenticated session may be created for each individual remote command that may be executed.

The authenticated session may be created by presenting credentials to the remote device in order to be granted access to perform a requested command. The credentials may be supplied by the shell environment by transmitting a user name and password or other credentials to the remote device, obtaining an authentication token from a domain server or cloud authentication mechanism, or some other authentication mechanism.

A request for the remote device may be generated in block 310 and transmitted in block 312. The request may be any form of communication and may comply with the remote device's mechanisms for receiving and processing.

A response from the remote device may be received in block 314. In block 316, the shell environment may transform the data received from the remote device to data that may be used within the shell environment. The transformation processes for incoming data may be similar to those used for transforming outgoing data described in block 306.

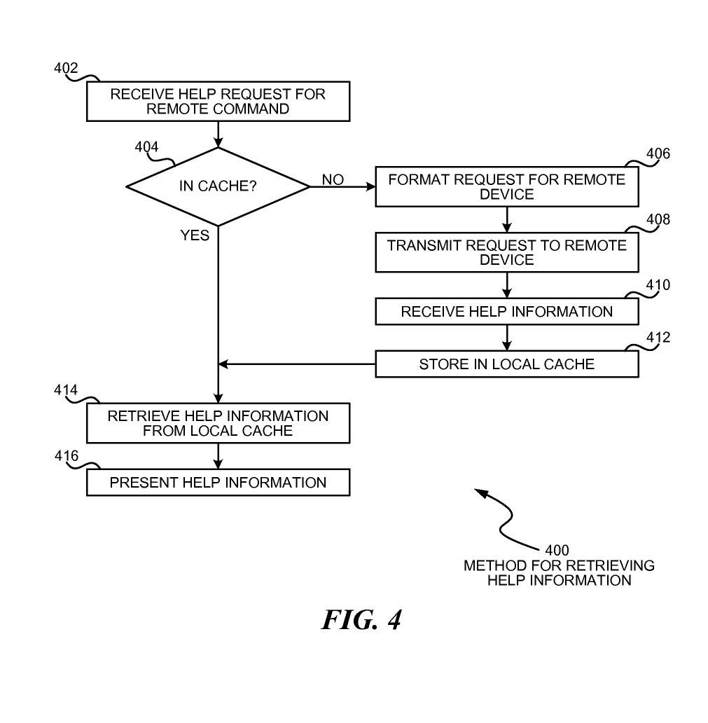

FIG. 4 is a flowchart illustration of an embodiment 400 showing a method for processing help requests within a shell environment.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is one mechanism by which help information may be retrieved and presented in a shell environment. The method of embodiment 400 requests help information on demand and stores the help information in a local cache. Other embodiments may download the help information during the process of embodiment 200, for example.

A help request may be received in block 402. The help request may be from a user typing in the command with a help flag or using some other mechanism to request information on the remote command. In some embodiments, a help command may be incorporated into a script for a remote command as an optional parameter.

If the help information is not in a local cache in block 404, a request may be prepared for the remote device in block 406 and transmitted to the remote device in block 408. The help information may be received in block 410 and stored in the local cache in block 412.

In some embodiments, the help information may be requested from a different device than the remote device. For example, a web service or other server may be configured to respond to help requests, and the request of block 408 may be transmitted to the other device.

In block 414, help information may be retrieved from the local cache and presented in the shell environment in block 416.

Each shell environment may have different manners for presenting help information. In some embodiments, help information may be displayed in a new window within a graphical user interface, such as a web browser for example. In many command line interfaces, the help information may be displayed directly onto the command line interface.

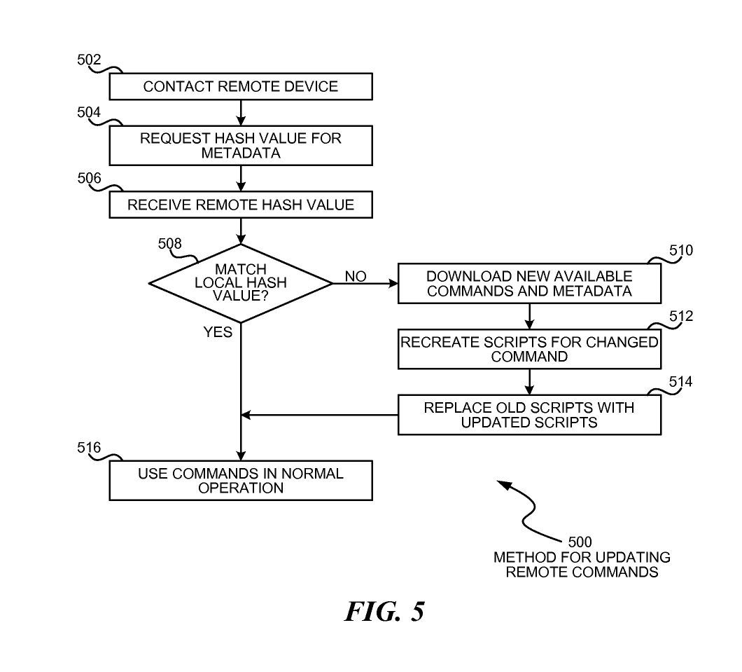

FIG. 5 is a flowchart illustration of an embodiment 500 showing a method for updating remote commands using hash values. Embodiment 500 is merely one method by which metadata and scripts stored in a cache may be updated periodically.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 is a method for determining if cached scripts may be outdated and updating those scripts. Embodiment 500 may be triggered by many different mechanisms, such as being performed on a periodic basis, such as daily, weekly, or some other frequency. Other mechanisms may be to perform embodiment 500 when a shell environment is started, or when a remote command is requested.

In block 502, a remote device is contacted and a hash value for the metadata is requested in block 504. The remote hash value may be received in block 506.

The remote hash value may be compared with the local hash value that may have been created in block 210 and stored in block 212. If the local hash value matches the remote hash value in block 508, the commands may be assumed to be unchanged and may be used in normal operation in block 516.

If the local hash value and remote hash value are different in block 508, new metadata may be downloaded in block 510, the scripts may be recreated using the new metadata in block 512, and the old scripts may be replaced with the new scripts in block 514. The process of creating new scripts from the metadata may be the same as blocks 216 through 226 of embodiment 200.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A shell environment operable on a computer processor, said shell environment configured to perform a method comprising:
receiving metadata from a remote device, said metadata relating to a set of remote commands available to be executed on said remote device;
for each remote command in said set of remote commands, creating a script to call said remote command, creating a local name for said script, and creating local command metadata for said script, said script being callable using said local name;
making said scripts available in said shell environment;
receiving a first local name to execute;
calling said script having said first local name and passing a first data object to said script;
sending a request to said remote device, a first portion of said request being at least defined in said script and a second portion of said request comprising said first data object;
receiving a remote response to said request from said remote device; and
providing a local response comprising at least a portion of said remote response.

2. The shell environment of claim 1, said metadata comprising an extended type definition for said first data object.

3. The shell environment of claim 1, said method further comprising:
authenticating a user for said first request by said remote device.

4. The shell environment of claim 3, said authenticating comprising transmitting credentials to a third device.

5. The shell environment of claim 1, said script having identical syntax to said remote command when said script is executed within said shell environment.

6. The shell environment of claim 1, said script being editable within said shell environment.

7. The shell environment of claim 1, said local name for said script comprising the same name for said command on said remote device.

8. The shell environment of claim 7, said local name for said script comprising an identifier for said remote device.

9. The shell environment of claim 1, said method further comprising:
receiving a help request for said script;
identifying said remote command within said script;
transmitting a help request to said remote device, said help request comprising said remote command;
receiving help information from said remote device; and
displaying at least a portion of said help information on said client device.

10. The shell environment of claim 9, said method further comprising:
storing said help information in a local cache.

11. The shell environment of claim 1, said method further comprising:
storing said metadata in a local cache.

12. The shell environment of claim 11, said method further comprising:
determining that said metadata in said local cache is outdated;
requesting updated metadata from said remote device; and
replacing said metadata with said updated metadata in said local cache.

13. The shell environment of claim 12, said method further comprising:
determining a first hash value for at least a portion of said metadata;
determining a second hash value for said update metadata; and
comparing said first hash value to said second hash value to determine that said metadata is outdated.

14. The shell environment of claim 1, said method further comprising:
defining a module comprising said scripts.

15. The shell environment of claim 14, said method further comprising:
assigning said module a module name; and
using said module name to call at least one of said scripts.

16. A system comprising:
a processor;
an operating system operable on said processor;
a shell environment operable with said operating system, said shell environment comprising:
a set of local commands, said local commands being directly executable within said shell environment;
a remote command management mechanism configured to perform a method comprising:
receiving metadata from said remote device, said metadata relating to said set of remote commands;
for each remote command in said set of remote commands, creating a script to call said remote command, creating a local name for said script, and creating local command metadata for said script, said script being callable using said local name;
making said scripts available in said shell environment;
an autocompletion mechanism configured to suggest at least one command in response to a partially defined command entered by a user.

17. The system of claim 16, said autocompletion mechanism configured to suggest at least one of said remote commands.

18. The system of claim 16, said shell environment comprising a command line interface.

19. A method comprising:
requesting metadata for a first remote command from a remote device;
receiving said metadata from said remote device, said metadata relating to said first remote command and comprising at least one complex data type for data passed to said first remote command;
creating a first script to call said first remote command;
making said first script available in said shell environment;
identifying a second script to execute;
creating a pipeline;
executing said first script and passing a first data object to said first script from said second script according to said pipeline;
sending a request to said remote device in response to executing said first script; and
receiving a remote response to said request from said remote device.

20. The method of claim 19 further comprising:
receiving a help request for said script;
identifying said remote command within said script;
transmitting a help request to said remote device, said help request comprising said remote command;
receiving help information from said remote device; and
displaying at least a portion of said help information on said client device.
